(19) United States
(12) Patent Application Publication
(10) Pub. No.: US 2016/0191350 A1
(43) Pub. Date: Jun. 30, 2016

(54) METHOD AND APPARATUS FOR DETERMINING OUTCOMES FROM DEVICE DATA TRAFFIC

(71) Applicant: Charles F. Kaminski, JR., Alpharetta, GA (US)

(72) Inventor: Charles F. Kaminski, JR., Alpharetta, GA (US)

(21) Appl. No.: 14/586,520

(22) Filed: Dec. 30, 2014

(51) Int. Cl. H04L 12/26; H04L 12/891; G06Q 30/02; H04L 29/08

(52) U.S. Cl. CPC H04L 43/062; H04L 67/22; H04L 47/41; G06Q 30/0202

(57) ABSTRACT

Data traffic is analyzed to determine, verify, or project outcomes. The data traffic may be generated by different sources, devices, or object devices. An activity or event may be determined using the analyzed data traffic. Possible outcomes may be determined by utilizing the activity or event.

### BACKGROUND

The proliferation and recordation of data has exploded due to the Internet, mobile computing, sensors, electronic transactions, or the like. The amount of stored data sets, sometimes referred to as “Big Data”, has grown rapidly. It is estimated that more scientific data has been generated in the past few years alone than the history of mankind. Petabytes (PBs), or one quadrillion bytes, of data now exist in databases or data farms across the world.

A challenge and opportunity exists in extrapolating intelligence from the petabytes or more stored in databases or data farms especially in substantially real-time. Although available, the data may exist in different formats, architectures, locations, or the like. It is desirable for a device or service to be able to utilize a large data store to extract valuable intelligence.

### SUMMARY

An apparatus and method to analyze data traffic to determine, verify, or project outcomes are disclosed. The data traffic may be generated by different sources, devices, or object devices. The data traffic may be obtained via public sources. An activity or event may be determined using the analyzed data traffic. Possible outcomes, such as economic, may be determined by utilizing the activity or event.

### BRIEF DESCRIPTION OF THE DRAWINGS

A more detailed understanding may be had from the following description, given by way of example in conjunction with the accompanying drawings wherein:

FIG. 1 is a system of object devices in an area that generate activity related data traffic;

FIG. 2 is an object device;

FIG. 3 is a process of determining outcomes using data traffic generated by identified object devices; and

FIG. 4 is a process of determining outcomes using data traffic generated by an identified cluster or group of object devices.

### DETAILED DESCRIPTION

Devices or processes will be described with reference to the drawing figures wherein like numerals represent like elements throughout. For the methods and processes described below, the steps recited may be performed out of sequence in any order and sub-steps not explicitly described or shown may be performed. In addition, “coupled” or “operatively coupled” may mean that objects are linked but may have zero or more intermediate objects between the linked objects.

Any combination of the disclosed features/elements may be used in one or more embodiments. Referring to “A or B” may include A, B, or A and B, which may be extended similarly to longer lists. When using the notation X/Y it may include X or Y. Alternatively, when using the notation X/Y it may include X and Y. X/Y notation may be extended similarly to longer lists with the same explained logic.

Forthcoming are devices and processes for identifying an object device or group/cluster of object devices using a large data set in order to determine current or future outcomes. Identification may be performed substantially in real-time. Substantially in real-time may be a nanosecond, microsecond, millisecond, minutes, hours, days, weeks, or any other timeframe relevant to a particular event, activity, or outcome.

Activity (e.g. movement, location changes, position changes, tracking, etc.) characteristics of the identified object device or group/cluster may be extrapolated with data analytics algorithms on the large data set. Activity characteristics may be utilized to determine events or roles associated with the object device or group/cluster. A group/cluster profile may be formed utilizing the activity characteristics. The activity characteristics, events, or roles may be used to infer possible current, near-term, or future outcomes. Outcomes may include possible economic or financial outcomes such an increase/decrease of sales, revenue, profit, or growth.

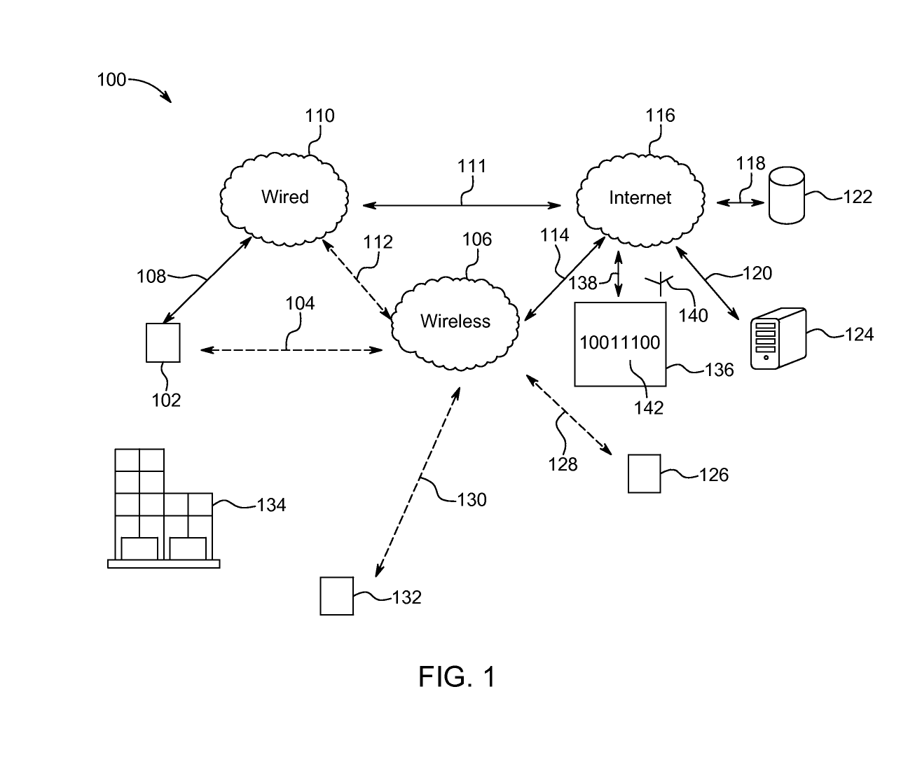

FIG. 1 is a system 100 of object devices in an area that generate activity related data traffic. Any one of object devices 102, 126, or 132 may be associated with a user, person, individual, company, worker, employee, executive, autonomous device, or the like that generates data traffic. Any one of object devices 102, 126, or 132 may be configured, substantially or in part, as object device 200 described below. Data traffic may include any one of voice data, digital call activity, analog related call activity, digital information, analog information, partially encrypted data, anonymous data, or the like.

In system 100, data traffic generated by object device 102 may be communicated to wired network 110 via wired link 108 with utilization of one or more network adapters 228. Wired network 110 may communicate the data traffic via wired link 111 to the Internet 116 or via wireless link 112 to wireless network 106. Wireless link 112 may be configured as a point-to-point communication link to send or relay information to wireless network 106 from wired network 110. Wireless network 106 may comprise one or more communication towers to communicate with any one of object devices 102, 126, or 132. Part of wireless network 106 may also be configured as a Wi-Fi, 802.11x, Bluetooth, or any other local area network (LAN) network.

Wireless network 106 can be configured to communicate data traffic via wired link 114 to the Internet 116. The Internet 116 may be configured to communicate any data traffic to Internet based database 122 via wired link 118 for storage. The Internet 116 may also communicate data traffic to server 124 via wired link 120. Data traffic generated by any one of object devices 102, 126, or 132 may also be communicated to wireless network 106 via wireless link 104 utilizing one or more network adapters 228.

Data aggregator device 136 may be configured to aggregate, detect, accumulate, and/or process any data traffic generated by any one of object devices 102, 126, or 132. Any detectable data traffic is stored in large data set 142. Part or substantially all of large data set 142 may be stored in Internet based database 122 or server 124. Large data set 142 may include both real-time and historical data from previously accumulated traffic data. Past data can be useful to verify with higher confidence or probability an activity related to an object device.

Data aggregator device 136 may be configured, substantially or in part, as object device 200 described below. Large data set 142 may be organized/stored in any one of a SQL database, database-management system (DBMS), Apache Hadoop environment, semi-structured database, structured database, cloud based storage environment, in-memory DBMS, analytical DBMS, Hadoop distribution platform, column-store DBMS, or the like. A combination or hybrid variety of database architectures may be configured based on a geographical region being monitored.

Data aggregator device 136 may communicate over the Internet 116 any data traffic or aggregation related information over wired link 138. One or more antennas 140 of data aggregator device 136 may be used to connect to wireless network 106 via a wireless link. In addition, one or more antennas 140 may be used by data aggregator device 136 to detect and aggregate substantially/partially/completely anonymous or identifiable data traffic communicated by object devices 102, 126, or 132 over any one of wireless links 104, 112, 128, or 130.

Data aggregator device 136 may be configured to utilize a packet analyzer, packet sniffer, or the like to detect anonymous over-the-air data traffic. Detected anonymous over-the-air data traffic may include any one of medium access control (MAC) addresses, IP addresses, a Wi-Fi basic service set identifier (BSSID), a service set identification (SSID), an extended service set (ESS), protocol indicators, any Wi-Fi identifier, any 802.11x identifier, global navigation satellite system (GNSS) related data, Global Positioning System (GPS) related data, mobile tower information, or the like communicated by any one of object devices 102, 126, or 132.

Identifying the mobile tower that object devices 102, 126, or 132 are associated with may be useful for tracking or positioning the object devices since it is easily detectable. Moreover, since mobile tower locations are at a fixed, publicly known location, data aggregator device 136 can fix an initial position for any one of object devices 102, 126, or 132. With the initial position, data aggregator device 136 may then determine if any one of object devices 102, 126, or 132 move when an association change with a mobile tower occurs.

Any one of object devices 102, 126, or 132 may be configured to directly provide GNSS related data or self-identifying related information to data aggregator device 136. Data aggregator device 136 may be configured to use such data to determine position or location of the respective object device. In addition, any one of object devices 102, 126, or 132 may provide radio-frequency identification (RFID) device or tag information to data aggregator device 136 for positioning or location of the respective object device.

Location or position of object device 102 may also be determined by the sharing of location of object devices. For instance, the location of object device 132 may be received by data aggregator device 136 with an indication that object device 102 is proximate/near object device 132. Proximity may be determined based on Bluetooth, RFID, or the like communication between object devices 102 and 132.

Large data set 142 may be utilized to identify any one of object devices 102, 126, or 132 substantially in real-time. In addition, large data set 142 may be utilized to identify if any one of object devices 102, 126, or 132 belongs to a group or cluster. Identification may determine if one or more devices 102, 126, or 132 is any one of an automobile, truck, train, vehicle, conveyance, delivery truck, mobile computer, smartphone, tablet, desktop computer, laptop computer, notebook computer, autonomous device, or the like. Identification may also determine if any one of object devices 102, 126, or 132 is associated with a user, person, individual, company, worker, consumer, operator, construction workers, or the like.

Identification may be made using one or more of data correlation, data pattern analysis, data flow analysis, data analytics, data stream-processing, data stream-analysis, in-memory processing, in-memory analysis, graph analyses, time-series analyses, data cleansing based analysis, columnar analytical parallel processing analysis, predication analysis, visualization, data skip searching, ad-hoc analysis, gap analysis, non-relational data analysis, batch analysis, map data overlaying, or the like by data aggregator device 136 and/or server 124.

In addition, data aggregator device 136 and/or server 124 may determine that object device 132 is moving at a speed over 40 miles per hour (MPH) while making substantially periodic stops based on data transmission detected via one or more antennas 140. Based on these data metrics, data aggregator device 136 and/or server 124 may conclude with some confidence that it is associated with a train for a period of time.

In another example, data traffic may be generated by an object device detected by data aggregator device 136 and/or server 124 traveling at a very high speed in city 1. After a time gap, within the same day the same object device may be detected by data aggregator device 136 and/or server 124 as traveling again in city 2 at a very high speed. This pattern in large data set 142 may indicate that the object device is an airplane or pilot. On the contrary, data aggregator device 136 and/or server 124 may have inconclusive processed results when it determines that an object device is moving in an unorganized or substantially erratic manner.

Once identified, a profile, classification, or role may be associated with any one of object devices 102, 126, or 132. The profile may include location or position related data that may be inferred from the identification or large data set 142. In addition to over-the-air detection by data aggregator device 136, any one of object devices 102, 126, or 132 may share or report location information to data aggregator device 136. With location or position related data, data aggregator device 136 may be able to directly track any one of object devices 102, 126, or 132 to determine an activity.

As an example, object devices 102 and 126 may be identified and profiled from large data set 142 as small trucks making shipments to building 134 over a previous time period T₁ (e.g. last week). A truck may be identified by determining if location data derived from large data set 142 for object device 126, for instance, is near or follows a known highway. This may be determined by overlaying or correlating crude/rough position related data traffic of object devices 102 and 126 over a map of an area where the data originated. A truck may also be determined by comparing communication temporal or time related information within large data set 142 to known shipment schedules.

The data points in large data set 142 may be sampled such that a time sequence of location or movement for object devices 102 and 126 is assembled over T₁. Building 134 may be a shipping facility, manufacturing facility, airport, warehouse, distribution center, fulfillment center, retail shop, big box store, mall, shopping center, government building, or the like.

During a current time period T₂, object devices 102, 126, and 132 may be identified as large trucks making shipments to building 134. The larger identified trucks and increase in shipments with three large trucks may be events utilized by data aggregator device 136 and/or server 124 to project/predict an increase of business event in a substantially real timeframe. The increased business event may be an increase in sales, profits, growth, expansion, or the like.

For more reliable measurements of activity at building 134, during T₂ a plurality of object devices may be identified using spatial or location characteristics as workers carrying smartphones in building 134 for a current indoor time period (T₃) from large data set 142. It may be determined that T₃ represents a statically significant increase in worker man hours in building 134 when compared to a comparable time period from large data set 142. A comparable time period may be based on data aggregated during an equivalent calendar period, same location, similar weather conditions, or the like.

The activity detected during T₂ and T₃ may be combined to form a cluster event. Activities detected during T₂ and T₃ may also be dynamically weighted when combined based on the type of outcome being projected. With multiple data points, a cluster event may increase the reliability or confidence that there is increased business activity near building 134 or the region associated with system 100. In addition, extrinsic metrics such as recent economic or growth trends in the area associated with system 100 may be factored into the cluster event.

In another example, data aggregator device 136 and/or server 124 may be configured to tag large trucks making shipments to building 134 as a predetermined role for a geographical region associated with system 100. Examples of a role may include weekly morning truck shipments, afternoon truck shipments, or the like. In addition, identified events from large data set 142 may be tagged as a coarse or fine event. An example of a coarse event may be weekly truck shipments made to building 134. An example of a fine event may be daily packages delivery by UPS or FedEx to building 134.

In addition, any one of object devices 102, 126, or 132 may subsequently be classified or tagged with a relevant economic role. A role may be determined based on the identification, activity, or event of an object device from large data set 142. An economic role may be that an object device, and/or data traffic produced by the object device, is related to manufacturing goods. Other roles may be mining, extracting raw materials, transporting goods, transporting raw materials, or the like. Transportation may include any one of ground, air, or ship. Such roles may be for an individual, group, or cluster of object devices. As explained herewith, once a role(s) for an object device(s) is determined it may be used for determining outcomes for a relevant company, firm, industry, or the like.

A classified or tagged role for any one of object devices 102, 126, or 132 may be dynamic or change over time. For instance, an object device identified as a truck driver delivering goods to a shipping port during the week may change roles to a father shopping at a grocery store over the weekend. The same object device at a subsequent time in the future may be associated with the role of a port worker off-loading cargo from a ship.

Investment decisions may be made if a projected or predicted outcome is an increase/decrease in business or economic events. For instance, an investor may base an interest rate related to loaning money to the landlord of building 134 using a substantially real-time statistically significant increase or decrease of business. As another investor, a mutual fund manager may increase or decrease stock holdings for a business operating in building 134 using a substantially real-time statistically significant increase or decrease of business.

As another example, a business or economic outcome determined based on the identification and activities of any one of object devices 102, 126, or 132 may be compared to historical records. Comparison to historical records may result in determining a more reliable projection of future economic or financial outcomes in connection with determined business activities.

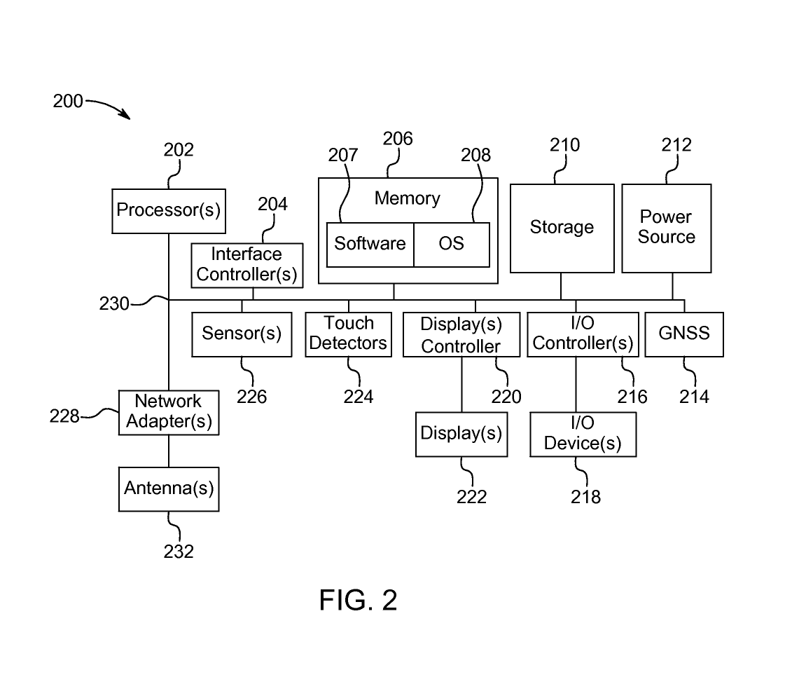

FIG. 2 is a diagram of an object device, or electronic device, 200. Different parts of object device 200 may be used to be configured as one or more of an automobile/truck, train/vehicle/conveyance computer system, automobile/truck/train/vehicle/conveyance controller, an autonomous device, a general computer, server, router, gateway, network device, core network device, cell tower, wireless subscriber unit, mobile device, user equipment (UE), mobile station, smartphone, pager, mobile computer, cellular phone, cellular telephone, telephone, personal digital assistant (PDA), computing device, surface computer, tablet, tablet computer, tablet/laptop combo device, sensor, machine, monitor, general display, versatile device, digital picture frame, appliance, television device, home appliance, home computer system, laptop, netbook, personal computer (PC), an Internet pad, digital music player, peripheral, add-on, an attachment, virtual reality glasses, media player, video game device, head-mounted display (HMD), helmet mounted display (HMD), glasses, goggles, wearable computer, wearable headset computer, optical head-mounted display (OHMD), Internet of Things (IoT) device, or any other electronic device for mobile or fixed applications.

In the forthcoming description of object device 200 certain described components may be specific to certain configurations. For instance, touch detectors 224 may be included when object device 200 is configured as a smartphone but not when it is a router.

Object device 200 comprises computer bus 230 that couples one or more processors 202, one or more interface controllers 204, memory 206 having software 207 or operating system (OS) 208, storage device 210, power source 212, and/or one or more displays controller 220. OS 208 may be based on one or more of Windows, OS X, WebOS, Linux, Unix, iOS, Android, QNX, C++, Java, or the like. OS 208 may include a kernel component that may manage input/output requests from software 207 in memory 206. The kernel may translate the request into data processing instructions for one or more processors 202 and other components of object device 200.

For certain configurations, object device 200 may comprise one or more display devices 222. One or more display devices 222 can be configured as a plasma, liquid crystal display (LCD), light emitting diode (LED), field emission display (FED), surface-conduction electron-emitter display (SED), organic light emitting diode (OLED), flexible OLED, a projection display, 4K display, high definition (HD) display, a Retina© display, In-Plane Switching (IPS) based display, or any other display device. The one or more display devices 222 may be configured, manufactured, produced, or assembled based on the descriptions provided in U.S. Patent Publication Nos. 2006-0096392, 2007-0139391, 2007-0085838, or 2011-0037792, or U.S. Pat. Nos. 6,882,333, 7,050,835, 8,400,384, or 8,466,873, or WO Publication No. 2007-012899 that are all herein incorporated by reference as if fully set forth.

In the case of a flexible or bendable display device, the one or more electronic display devices 222 may be configured and assembled using organic light emitting diodes (OLED), liquid crystal displays using flexible substrate technology, flexible transistors, field emission displays (FED) using flexible substrate technology, or the like. Any one of the provided display devices herein may be self-lighting or use backlighting sources (e.g. LED). One or more display devices 222 may be wholly or partially transparent, using one of the display technologies mentioned herewith.

One or more display devices 222 can be configured as a touch, multi-input touch, multiple input touch, multiple touch, or multi-touch screen display using resistive, capacitive, surface-acoustic wave (SAW) capacitive, infrared, strain gauge, optical imaging, dispersive signal technology, acoustic pulse recognition, frustrated total internal reflection, or magneto-strictive technology, as understood by one of ordinary skill in the art. One or more display devices 222 can also be configured as a three dimensional (3D), electronic paper (e-paper), or electronic ink (e-ink) display device.

Coupled to one or more display devices 222 via computer bus 230 may be one or more input/output (I/O) controllers 216, I/O devices 218, GNSS device 214, one or more network adapters 228, and/or one or more antennas 232. Examples of I/O devices include a speaker, microphone, keyboard, keypad, touchpad, display, touchscreen, wireless gesture device, a camera, a digital camera, a digital video recorder, a vibration device, universal serial bus (USB) connection, a USB device, or the like. An example of GNSS is the GPS. The camera may be digital single-lens reflex (DSLR) camera, single-lens reflex (SLR) camera, or the like. The digital camera may also be configured to generate images that are then adjusted using high-dynamic-range (HDR) image processing.

For certain configurations, object device 200 may have one or more motion, proximity, light, optical, chemical, biological, medical, environmental, barometric, atmospheric pressure, moisture, acoustic, audible, heat, temperature, metal detector, RFID, biometric, face recognition, facial recognition, image, infrared, camera, photo, or voice recognition sensor(s) 226. Examples of image, photo, text, or character recognition engines are provided by U.S. Patent Publication Nos. 2011-0110594 or 2012-0102552 that are both herein incorporated by reference as if fully set forth.

For certain configurations, one or more sensors 226 may also be an accelerometer, an electronic compass (e-compass), a gyroscope, a 3D gyroscope, a 3D accelerometer, a 4D gyroscope, a 4D accelerometer, or the like. One or more sensors 226 may operate with respective software engines/components in software (207)/OS (208) to interpret/discern/process detected measurements, signals, fields, stimuli, inputs, or the like.

For certain configurations, object device 200 may also have touch detectors 224 for detecting any touch inputs, multi-input touch inputs, multiple input touch inputs, multiple touch inputs, or multi-touch inputs for one or more display devices 222. Touch detectors 224 may be configured with one or more display devices 222 as provided in U.S. Pat. Nos. 6,323,846 or 7,705,830 that are both herein incorporated by reference as if fully set forth. One or more interface controllers 204 may communicate with touch detectors 224 and I/O controllers 216 for determining user inputs to object device 200. Touch detectors 224 may be integrated into one or more display devices 222 to determine any user gestures or inputs.

Still referring to object device 200, storage device 210 may be any disk based or solid state memory device for storing data. Storage device 210 may be configured to work in coordination with cloud based storage (not shown) via one or more network adapters 228. Power source 212 may be a plug-in, battery, solar panels for receiving and storing solar energy, or a device for receiving and storing wireless power.

One or more network adapters 228 may be configured as a Frequency Division Multiple Access (FDMA), single carrier FDMA (SC-FDMA), Orthogonal Frequency-Division Multiplexing (OFDM), Orthogonal Frequency-Division Multiple Access (OFDMA), Time Division Multiple Access (TDMA), Code Division Multiple Access (CDMA), cdma2000, Global System for Mobile (GSM) communications, Interim Standard 95 (IS-95), IS-856, Enhanced Data rates for GSM Evolution (EDGE), General Packet Radio Service (GPRS), Universal Mobile Telecommunications System (UMTS), wideband CDMA (W-CDMA), High-Speed Downlink Packet Access (HSDPA), High-Speed Uplink Packet Access (HSUPA), High-Speed Packet Access (HSPA), Evolved HSPA (HSPA+), Long Term Evolution (LTE), LTE Advanced (LTE-A), 802.11x, Wi-Fi, Zigbee, Ultra-WideBand (UWB), 802.16x, 802.15, Wi-Max, mobile Wi-Max, home Node-B (HnB), Bluetooth, radio frequency identification (RFID), Infrared Data Association (IrDA), near-field communications (NFC), fifth generation (5G), or any other wireless device/transceiver for communication via one or more antennas 232. One or more network adapters 228 may also be configured as an Ethernet, 802.3, digital subscriber line (DSL), cable modem, or optical device/transceiver to communicate via wired links (not shown).

One or more network adapters 228 may also be configured for automobile to automobile, car to car, vehicle to vehicle (V2V), or wireless access for vehicular environments (WAVE) communication. In addition, any of the communication links referenced herewith may be wired or wireless or both wired and wireless.

Any of devices, controllers, displays, components, etc. in object device 200 may be combined, made integral, or separated as desired. Any of the forthcoming configurations, systems, or operations may be provided in or by object device 200. Any of the forthcoming configurations, systems, or operations may also be provided in or by any mobile device.

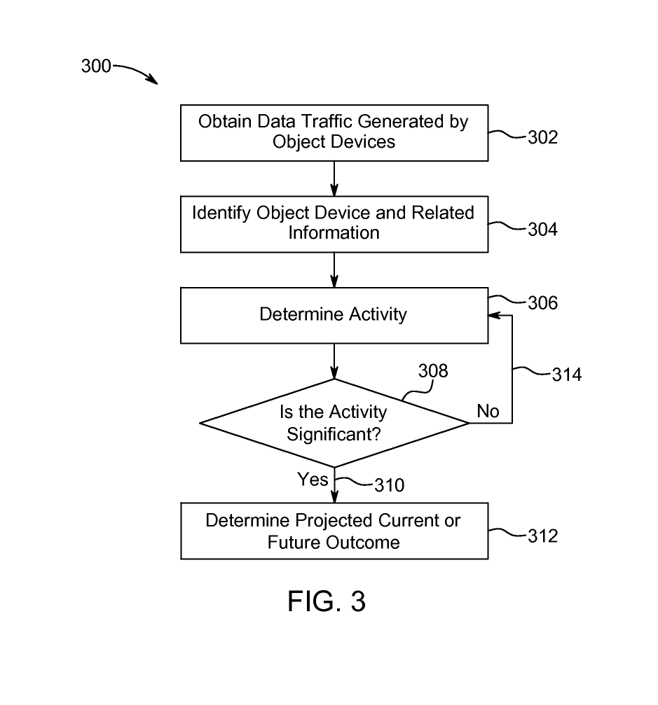

FIG. 3 is a process 300 of determining outcomes using data traffic generated by identified object devices. Process 300 may be used in conjunction with any of the devices or techniques provided above. Data traffic generated by any one of object devices 102, 126, or 132 may be obtained (302). The obtained data traffic may be substantially/partially/completely anonymous or provided directly by any one of object devices 102, 126, or 132. Any one of object devices 102, 126, or 132 and any respective related information may then be identified (304). Related information may include any one of a communicated medium access control (MAC) address(s), Internet Protocol (IP) address(s), Wi-Fi basic service set identifier (BSSID), service set identification (SSID), extended service set (ESS), protocol types, Wi-Fi identifier, 802.11x identifier, global navigation satellite system (GNSS) related data, Global Positioning System (GPS) related data, mobile tower information, or the like.

An activity may be determined of any one of object devices 102, 126, or 132 (306). The significance of the activity may then be determined (308). Significance of the activity may be made in association with a related probability or confidence level of the activity. Significance of the activity may also be made in relation to an identified object device being involved in an event that has an important role in an economy. For instance, an object device being related to a user that is 24-35 years old may be identified as spending more time than usual in a shopping mall. This event may be more significant on the local economy than if the user is 12-18 years old since 24-35 years old are generally known to be more profitable to a business.

If the activity of any one of object devices 102, 126, or 132 is significant (310), a projected current or future outcome is determined (312). A current or future outcome may be an economic outcome such as an increase in sales, higher profit, increased cash flow, decreased sales, decreased profit, or the like. If the activity is insignificant (314), any one of object devices 102, 126, or 132 may be continued to be monitored for activity (306).

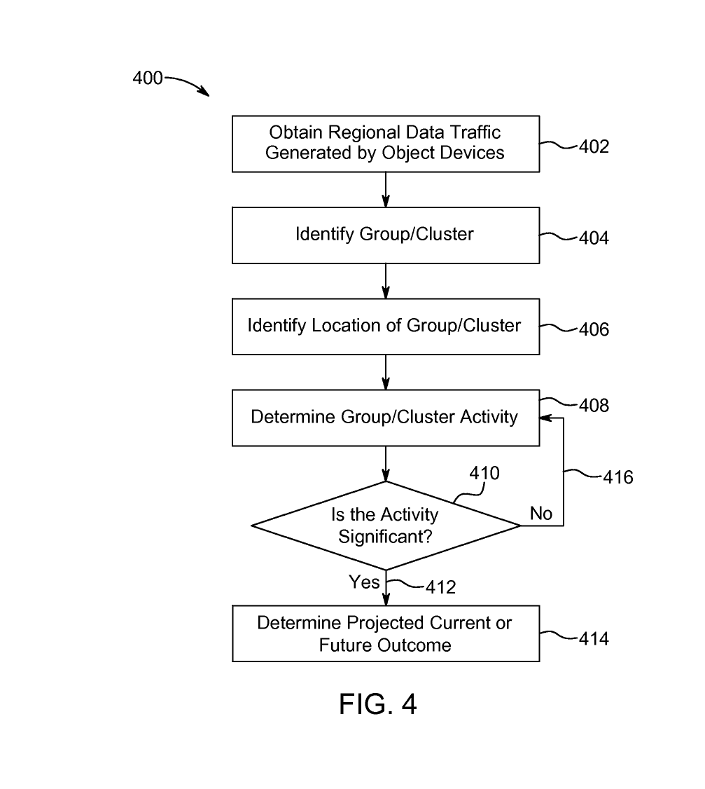

FIG. 4 is a process 400 of determining outcomes using data traffic generated by an identified cluster or group of object devices. Process 400 may be used in conjunction with any of the devices or techniques provided above. Regional data traffic generated by any one of object devices 102, 126, or 132 may be obtained (402). The data traffic may be obtained by data aggregator device 136 by detecting over-the-air transmissions by any one of object devices 102, 126, or 132 to a wireless network. The obtained data traffic may be substantially/partially/completely anonymous or provided directly by any one of object devices 102, 126, or 132. Any one of object devices 102, 126, or 132 may be identified as a group/cluster (404) using the techniques described herewith. The location of the group/cluster may be identified and subsequently tracked (406).

An activity may be determined of the group/cluster (408). It may be determined if the activity is significant (410). Significance of the activity may be made in association with a related probability or confidence level of the activity. Significance of the activity may also be made in relation to an identified group/cluster being involved in an event that has an important role in an economy. For instance, a smaller than usual group/cluster of shoppers entering a building at the same time on Black Friday when a large store opens may be a significant event.

If the activity of a group/cluster is significant (412), a projected current or future outcome is determined (414). A current or future outcome may be an economic outcome such as an increase in sales, higher profit, increased cash flow, decreased sales, decreased profit, or the like. If the activity is insignificant (416), the group/cluster may be continued to be monitored for activity (408).

Although features and elements are described above in particular combinations, each feature or element may be used alone without the other features and elements in various combinations, in any permutation, or any desired order. In addition, a processor in coordination or association with software may be used to implement hardware functions. The programmed hardware functions may be used in conjunction with modules, implemented in hardware and/or software. Modules may be a display, a liquid crystal display (LCD) display unit, an organic light-emitting diode (OLED) display unit, a flexible display, a camera, a video camera module, a videophone, a speakerphone, a vibration device, a speaker, a microphone, a television transceiver, a hands free headset, a keyboard, a Bluetooth® module, a digital music player, a media player, a video game player module, an Internet browser, and/or any wireless local area network (WLAN).

The operations, methods, processes, or flow charts provided herein may be implemented or performed in a computer function, computer program, software, hardware, circuitry, configured circuitry, anyware, firmware, or the like. This information or data may be stored in a computer-readable storage medium for execution by a processor, computer, or a controller.

Processors to execute/process software, instructions, or functions may include a general purpose processor, a system on a chip (SoC), Application Specific Integrated Circuits (ASICs), a multicore processor, a special purpose processor, a microcontroller, a conventional processor, a digital signal processor (DSP), a plurality of microprocessors, one or more microprocessors in association with an ASIC or DSP core, Field Programmable Gate Arrays (FPGAs) circuits, any other type of integrated circuit (IC), and/or a state machine. Computer-readable storage mediums include a read only memory (ROM), electrical signals, a random access memory (RAM), a register, cache memory, semiconductor memory devices, magnetic media such as internal hard disks and removable disks, magneto-optical media, and optical media such as CD-ROM disks, digital versatile disks (DVDs), high definition video discs.

What is claimed is:

1. A method performed by a computer, the method comprising:
receiving, by a transceiver of the computer, data traffic related to a plurality of object devices;
storing, by the computer, the data traffic into a data set, wherein the data set comprises aggregated data related to the plurality of object devices;
identifying, by the computer, at least one object device of the plurality of object devices from the data set; and
determining, by the computer from the data set, an activity and event related to the identified at least one object device.

2. The method of claim 1 further comprising:
determining, by the computer from the data set, significance of the activity, wherein an economic impact is determined based on in part the significance of the activity.

3. The method of claim 1 further comprising:
projecting an outcome based on the determined activity and event; and
wherein the projected outcome is a projected economic outcome or a projected financial outcome.

4. The method of claim 1, wherein the data traffic is received from a data aggregator device and the data aggregator device obtains the data traffic in substantially real-time from over-the-air public data traffic transmissions.

5. The method of claim 1, wherein the at least one object device is associated with a user or a conveyance.

6. The method of claim 1, wherein the data set includes aggregated data received from a data aggregator device.

7. The method of claim 1, wherein the activity or the event is determined based on position, location, tracking, or movement related information of the at least one object device derived by the computer from the data set.

8. The method of claim 1, wherein the data set includes a semi-structured database with anonymous object device data and object device provided data.

9. A method performed by a computer, the method comprising:
receiving, by the computer, data traffic related to a plurality of object devices;
identifying, by the computer, a group of object devices from the data traffic;
tracking, by the computer, the group of object devices; and
determining, by the computer, an activity and event of the tracked group of object devices.

10. The method of claim 9 further comprising:
determining, by the computer from the data traffic, significance of the activity, wherein an economic impact is determined based on in part the significance of the activity.

11. The method of claim 9 further comprising:
projecting an outcome based on the determined activity and event; and
wherein the projected outcome is a projected economic outcome or a projected financial outcome.

12. The method of claim 9, wherein the data traffic is received from a data aggregator device and the data aggregator device obtains the data traffic from over-the-air public data traffic transmissions.

13. A computer characterized in that:
a transceiver is configured to receive data traffic related to a plurality of object devices;
the computer is configured to store the data traffic into a data set, wherein the data set comprises aggregated data related to the plurality of object devices;
the computer is configured to identify at least one object device of the plurality of object devices from the data set; and
the computer is configured to determine, from the data set, an activity and event related to the identified at least one object device.

14. The computer of claim 13 further characterized in that:
the computer is further configured to determine, from the data set, significance of the activity, wherein an economic impact is determined based on in part the significance of the activity.

15. The computer of claim 13 further characterized in that:
the computer is configured to project an outcome based on the determined activity and event; and
wherein the projected outcome is a projected economic outcome or a projected financial outcome.

16. The computer of claim 13, wherein the data traffic is received from a data aggregator device and the data aggregator device obtains the data traffic in real-time from over-the-air public data traffic transmissions.

17. The computer of claim 13, wherein the at least one object device is associated with a user or a conveyance.

18. The computer of claim 13, wherein the data set includes aggregated data received from a data aggregator device.

19. The computer of claim 13, wherein the activity or the event is determined based on position, location, tracking, or movement related information of the at least one object device derived from the data set.

20. The computer of claim 13, wherein the data set includes a semi-structured database with anonymous object device data and object device provided data.
